(19) United States
(12) Patent Application Publication
(10) Pub. No.: US 2010/0313995 A1
(43) Pub. Date: Dec. 16, 2010

(54) ROBOT FOR ORCHESTRATING MICROFLUIDICS EXPERIMENTS

(76) Inventors: Cory Gerdts, Romeoville, IL (US); Andrew M. Lovatt, Royston (GB); Paul M. Crisp, Royston (GB); Peter Nollert-von Specht, Bainbridge Island, WA (US); Lansing J. Stewart, Bainbridge Island, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/794,330

(22) Filed: Jun. 4, 2010

Related U.S. Application Data
(60) Provisional application No. 61/187,234, filed on Jun. 15, 2009.

(51) Int. Cl. B67C 3/26

(52) U.S. Cl. 141/284

(57) ABSTRACT

A robot is described for automatically performing microfluidic experiments that are often complex and repetitive. The robot includes a system for initiating the communication of off-chip fluids, such as fluorocarbons, and off-chip materials, such as proteins. The communication of off-chip fluids and off-chip materials is further guided to a microfluidics device vis-à-vis a Z-head robot, an XY plane robot, and an interface assembly that creates a fluid-tight joint for communicating the off-chip fluids and off-chip materials into the microfluidics device for conduction of microfluidics experiments.

### CROSS-REFERENCE TO RELATED APPLICATION

The application claims the benefit of Provisional Application No. 61/187,234, filed Jun. 15, 2009, which is incorporated herein by reference.

### BACKGROUND

Microfluidics is a field of science focusing on the behavior and conduction of fluids that are physically constrained to very small scale structures. The science is a multidisciplinary field combining engineering, physics, chemistry, microtechnology, and biotechnology to produce practical applications in which very small volumes of fluids will be used. Microfluidics science gained notoriety within the last thirty years as the successful commercialization of various projects has taken off, such as inkjet printheads and lab-on-a-chip technology.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

One aspect of the subject matter includes a system form, which describes a robot for orchestrating fluidic experiments. The robot comprises a macro-micro interface assembly configured to receive a microfluidics device. The robot further comprises a Z-head configured to protract a sheath, which houses a tube having a terminus that mates with the macro-micro interface assembly to make a fluid-tight joint for communicating fluid into the microfluidics device. The Z-head is further configured to retract the sheath to unmake the fluidic-tight joint between the terminus of the tube and the microfluidics device.

Another aspect of the subject matter includes a device form, which describes an interface assembly. The interface assembly comprises an upper macro-micro interface configured to define a number of guide orifices. The interface assembly further comprises a lower macro-micro interface configured to define a front whose upper terminus houses various interface ports and whose lower terminus houses hemicycles. Each guide orifice is axially aligned with each respective interface port and each respective hemicycle. Fastened into the lower macro-micro interface between the interface ports and the hemicycles is a microfluidics device in which a subset of columnar ports of the microfluidics device fit into the hemicycles, which further respectively align with interface apertures of the microfluidics device.

A further aspect of the subject matter includes another device form, which describes a Z-head robot. The Z-head robot comprises a set of S-shaped male selectors fastened to a set of sheaths that house tubes. The Z-head robot also comprises a set of female selectors, each of which includes a C-shaped selector opening. Furthermore, the Z-head robot comprises a cam, which is an assembly of disk members with apices that rotate to transform rotary motion into linear motion, the Z-head robot lowering one or more apices of the disk members of the cam so that the lowered apices contact one or more female selectors, causing one or more C-shaped selector openings to mate with proximal termini of one or more S-shaped male selectors and thereby selecting one or more sheaths.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an isometric, perspective diagram from leftward front illustrating an archetypical robot for orchestrating fluidic experiments;

FIG. 2 is an isometric, perspective diagram from leftward front illustrating an archetypical robot for orchestrating fluidic experiments;

FIG. 3 is an isometric, perspective diagram from leftward front illustrating a portion of an archetypical robot for orchestrating fluidic experiments;

FIG. 4 is an isometric, perspective diagram from rightward front illustrating an archetypical robot for orchestrating fluidic experiments;

FIG. 5 is an isometric, perspective diagram from rightward front illustrating a portion of an archetypical robot for orchestrating fluidic experiments;

FIG. 6 is an isometric, perspective diagram from rightward front illustrating a portion of an archetypical robot, specifically an XY plane robot, for orchestrating fluidic experiments;

FIG. 7 is an isometric, perspective diagram from leftward front illustrating a portion of an archetypical robot, specifically an XY plane robot, for orchestrating fluidic experiments; FIG. 7A is an isometric, perspective diagram illustrating a portion of an archetypical XY terminus device;

FIG. 8 is an exploded isometric, perspective diagram from leftward front illustrating an archetypical experiment platform and an archetypical drip stage;

FIG. 9A is an exploded isometric, perspective diagram from leftward front illustrating a portion of an archetypical interface assembly; FIG. 9B is an exploded isometric, perspective diagram from leftward back illustrating a portion of an archetypical interface assembly;

FIG. 10A is an assembled, isometric, perspective diagram from leftward back illustrating an archetypical interface assembly; FIG. 10B is an exploded, isometric, perspective diagram from leftward front illustrating an archetypical interface assembly;

FIG. 11 is an assembled, isometric, perspective diagram from leftward front illustrating an archetypical interface assembly;

FIG. 12 is an isometric, perspective diagram from rightward front illustrating a portion of an archetypical robot, specifically a Z-head robot, for orchestrating fluidic experiments;

FIG. 13 is an isometric, perspective diagram from rightward front illustrating the innards of an archetypical Z-head robot;

FIG. 14 is an exploded isometric, perspective diagram from rightward front illustrating archetypical innards of an archetypical Z-head robot;

FIG. 15 is an assembled isometric, perspective diagram from rightward front illustrating a portion of an archetypical Z-head robot, specifically an archetypical selection mechanism;

FIG. 16 is an exploded isometric, perspective diagram from rightward front illustrating a portion of an archetypical Z-head robot, specifically an archetypical selection mechanism;

FIG. 17A is a partial cross-sectional diagram from rightward side illustrating a portion of archetypical innards of an archetypical Z-head robot, specifically, an archetypical disc member of an archetypical cam and an archetypical female selector in a pre-select state; FIG. 17B is a partial cross-sectional diagram from rightward side illustrating a portion of archetypical innards of an archetypical Z-head robot, specifically, an archetypical disc member of an archetypical cam and an archetypical female selector in a post-select state;

FIG. 18A is a partial cross-sectional diagram from rightward side illustrating a portion of an archetypical robot, specifically an archetypical compression/decompression structure in a pre-compressed or decompressed state;

FIG. 18B is a partial cross-sectional diagram from rightward side illustrating a portion of an archetypical robot, specifically, an archetypical compression/decompression structure in a compressed or post-compressed state;

FIG. 19 is an assembled, isometric, perspective diagram from rightward front illustrating a portion of an archetypical robot, specifically an archetypical compression/decompression structure;

FIG. 20 is an assembled, isometric, perspective diagram from rightward back illustrating a portion of an archetypical robot, specifically an archetypical compression/decompression structure;

FIG. 21 is an assembled, isometric, perspective diagram from leftward back illustrating a portion of an archetypical robot, specifically an archetypical compression/decompression structure; and

FIG. 22 is an exploded, isometric, perspective diagram from rightward front illustrating a portion of an archetypical robot, specifically an archetypical compression/decompression structure.

### DETAILED DESCRIPTION

Various embodiments of the present subject matter include a robot 100 for automatically performing microfluidic experiments that are often complex and repetitive. The robot 100 of various embodiments of the present subject matter includes systems for initiating the communication of off-chip fluids, such as fluorocarbon, and off-chip materials, such as proteins. The communication of off-chip fluids and off-chip materials is further guided to a microfluidics device vis-à-vis a Z-head robot 500, and an XY plane robot 400, and an interface assembly 306 that creates a fluid-tight joint for communicating the off-chip fluids and off-chip materials into the microfluidics device for conduction of microfluidics experiments, such as protein crystallization. The robot 100 triaxially orchestrates the Z-head robot 500 to coordinate movements of tubes 506A-D in the z-axis, the XY plane robot 400 to coordinate movements of an XY stage 408 (on which off-chip materials are housed) in both the x-axis and the y-axis, so as to load off-chip fluids and off-chip materials into the tubes 560A-D for eventual communication to a microfluidics device 326 held by the interface assembly 306.

In one embodiment of the present subject matter, the robot orchestrates continuous or discrete liquid flow through microfabricated channels of the microfluidics device. Actuation of liquid flow is implemented by external pressure sources, such as external mechanical pumps 208A-D. The orchestration by the robot collaterally facilitates reduction or elimination of material fouling, such as proteins. The robot 100 can be programmed by software to be familiar with various biochemical applications and is particularly suitable for orchestrating chemical separation, as well as for applications that require a high degree of flexibility or complex fluid manipulations. Many different suitable experiments may be conducted, some of which include molecule crystallization, enzymatic analysis, DNA analysis, proteomics analysis, clinical pathology, and environmental testing.

In one illustrative embodiment, after the Z-head robot 500 in combination with the XY plane robot 400 has caused the tubes 506A-D to mate with the microfluidics device 326, the robot 100 coordinates microfluidics crystallization experiments by controlling the flow of aqueous samples stored on a 96-well plate 406, immiscible fluorocarbon samples stored in vials 224A-D, and off-chip materials stored in a tube rack 416. The microfluidics crystallization experiments produce aqueous droplets in the microfluidics device 326 of about 10-20 nanoliters each. Each aqueous droplet is a microfluidics experiment (depending on the experiment protocol) different from another aqueous droplet. The composition of each aqueous droplet is known to the robot 100 because it controls the flow rates of off-chip fluids and off-chip materials using pumps 208A-D to control syringes 210A-210D, which are fluidically coupled to the tubes 506A-D. Because the robot 100 can be programmed by software to execute different experiment protocols, the robot 100 can generate relatively smooth concentration gradients over a series of aqueous droplets in the microfluidics device 326. In addition, the robot 100 may execute experimental protocols to create either sparse matrix experiments or gradient experiments via a hybrid method, which utilizes a preformed cartridge of different precipitants to sample a single protein material against many different precipitants.

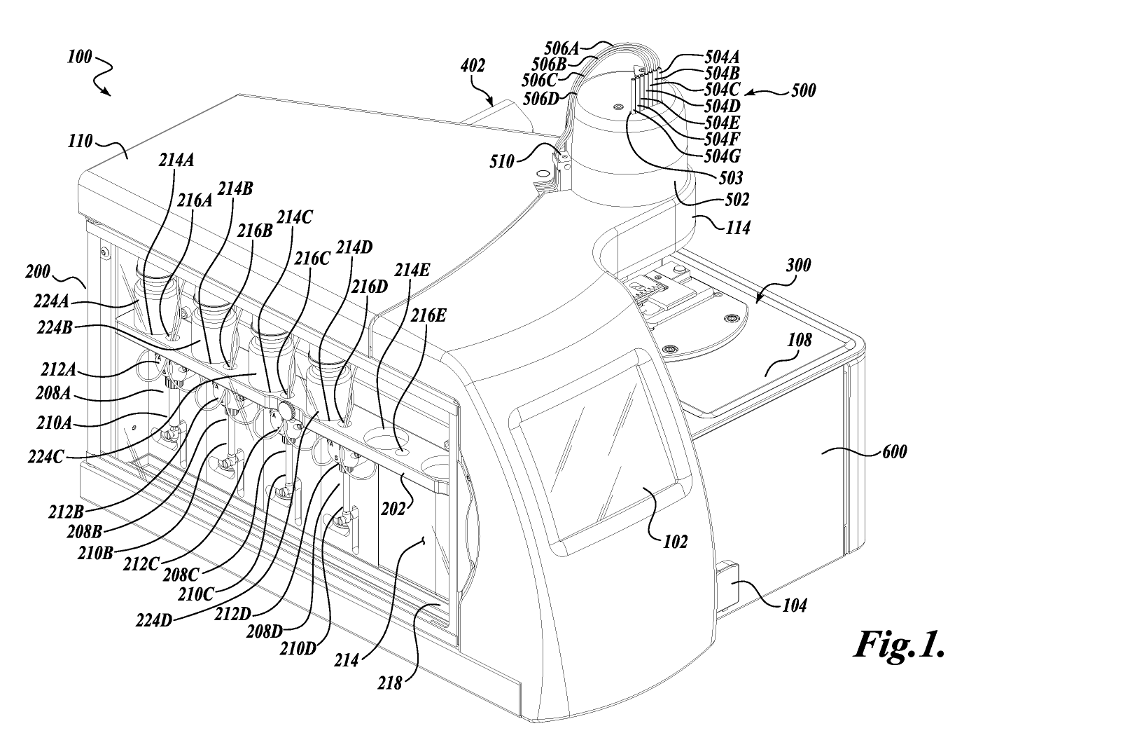

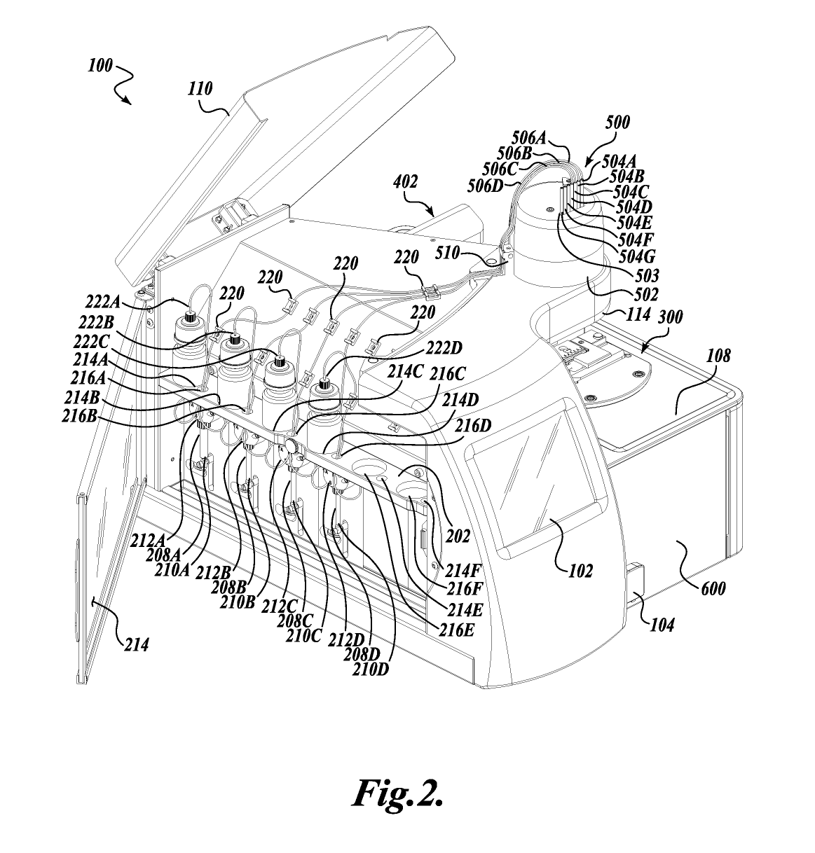

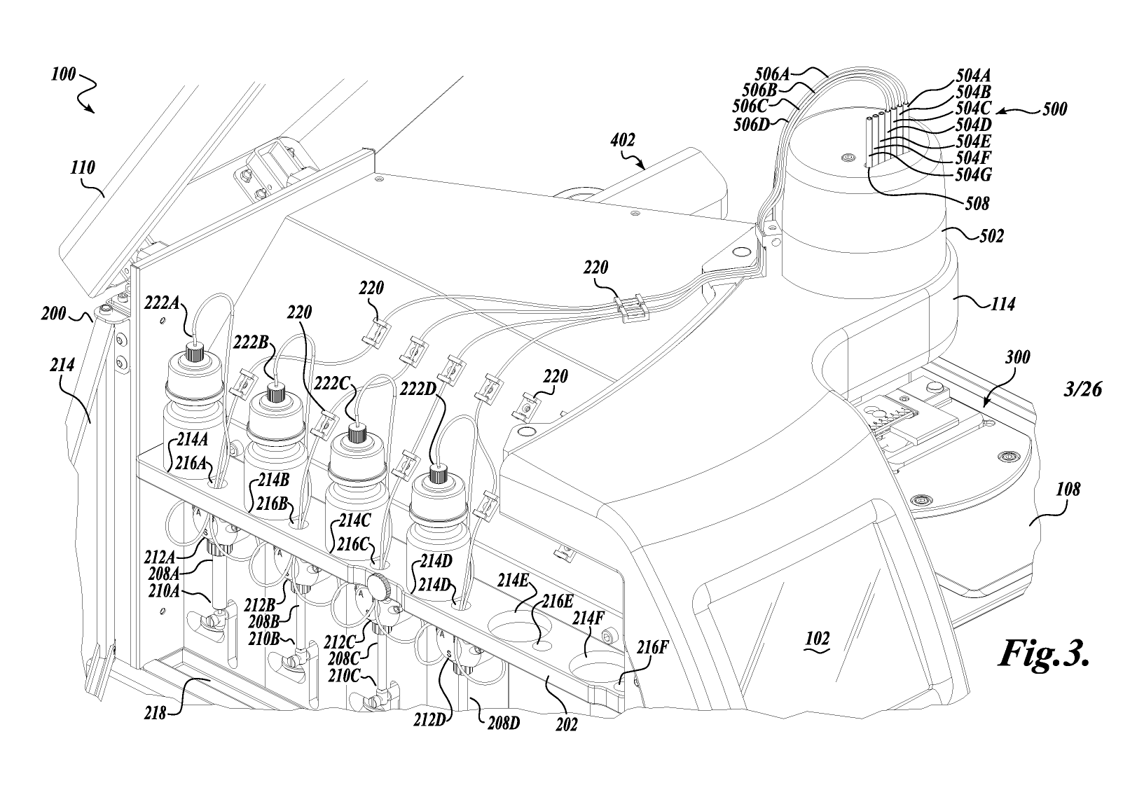

The robot 100 for orchestrating fluidic experiments, according to user-programmable protocols, is illustrated from leftward front at FIGS. 1-3. The robot 100 is conceptually divided into five sections, including a side bar 200, an experiment platform 300, the XY plane robot 400, the Z-head 500, and a side box 600, all of which, alone or in combination, facilitate movements of tubes 506A-D. A top cover 110 is situated over the body of the robot 100, and is hinged at the back of the robot 100, facilitating its opening. The side bar 200 is encased behind a glass side door 214, which is hinged to secure its opening. The side bar 200 is architecturally divided into an upper portion and a lower portion. The two portions are separated by a vial rack 202, which defines a number of vial sinks 214A-F and numerous rack holes 216A-F. Various vials 224A-D sit securely in a set of vial sinks 214A-F. Suitably vials 224A-D store fluids such as fluorocarbon. In a special embodiment, the vials 224A-D can be reduced to a single vial. The rack holes 216A-F allow tubes, such as tubes 506A-D and vial tubes 222A-D, to be threaded toward the lower portion of the side bar 200. The lower portion of the side bar 200 includes a number of valves 212A-D for regulating fluid flow (and permitting quicker priming) as they are conducted by a series of syringes 210A-D, which are controlled by pumps 208A-D. The glass side door 214 allows visual inspection of the syringes 210A-D to ease troubleshooting. The pumps 208A-D, in one embodiment, suitably provide relatively smooth and step-wise gradients of fluids by dynamically changing the flow rate of fluids contemporaneously. The syringes 210A-D are suitably oriented in an upright orientation so as to assist air bubbles to move to the top of the syringe. The syringes 210A-D facilitate not only aspiring but also dispensing at any suitable resolution, including 50 nanoliters per minute with a one minute or better response time. More particularly, each of the valves 212A-D has three ports, one port being coupled to a tube 506A-D, another port being coupled to the a vial tube 222A-D, and the remaining port being coupled to a syringe 210A-D. At the bottom of the side bar 200 is a side trough 218 for catching spillage of liquids.

The front of the robot 100 includes a touchscreen 102. The touchscreen 102 is used to define desired experimental protocols or to cause a pre-defined experimental protocol to execute after placing suitable off-chip fluidics and off-chip materials into various locations, such as O.D. tubes in the tube rack 416, the 96-well plate 406, and the vials 224A-D. Next to the touch screen 102 is a side box 600 whose front presents a USB port 104. Above the side box 600 is a drip stage 108. On top of the drip stage 108 is the experiment platform 300. Hovering above the experiment platform 300 is a ledge 114, which extends from the body of the robot 100, on top of which is a cover 502 for the Z-head 500. At the top of the cover 502 is a slit 508, defined as sheath opening. A number of sheaths 504A-G protrude from the sheath opening 508. Various tubes for conducting fluid 506A-D are housed by the sheaths 504A-G, which are gathered by a tube guide 510. The tube guide 510 is positioned adjacent to the cover 502 and together with other tube guides 220 gather the tubes 506A-D and orient them toward the side bar 200. A Y carriage 402 of the XY plane robot 400 peeks rightward of the robot 100.

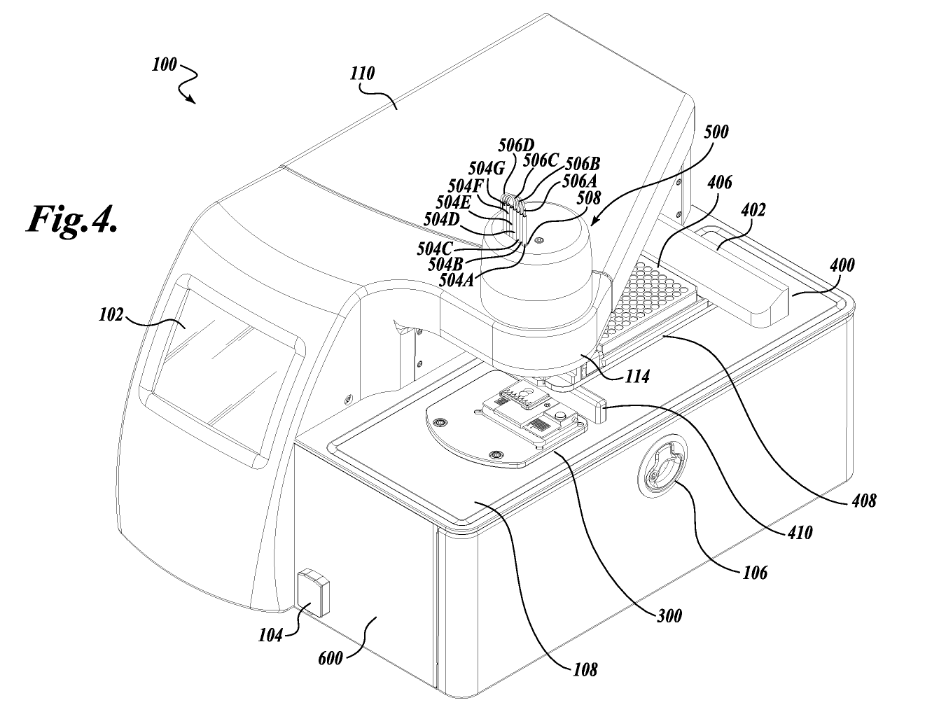

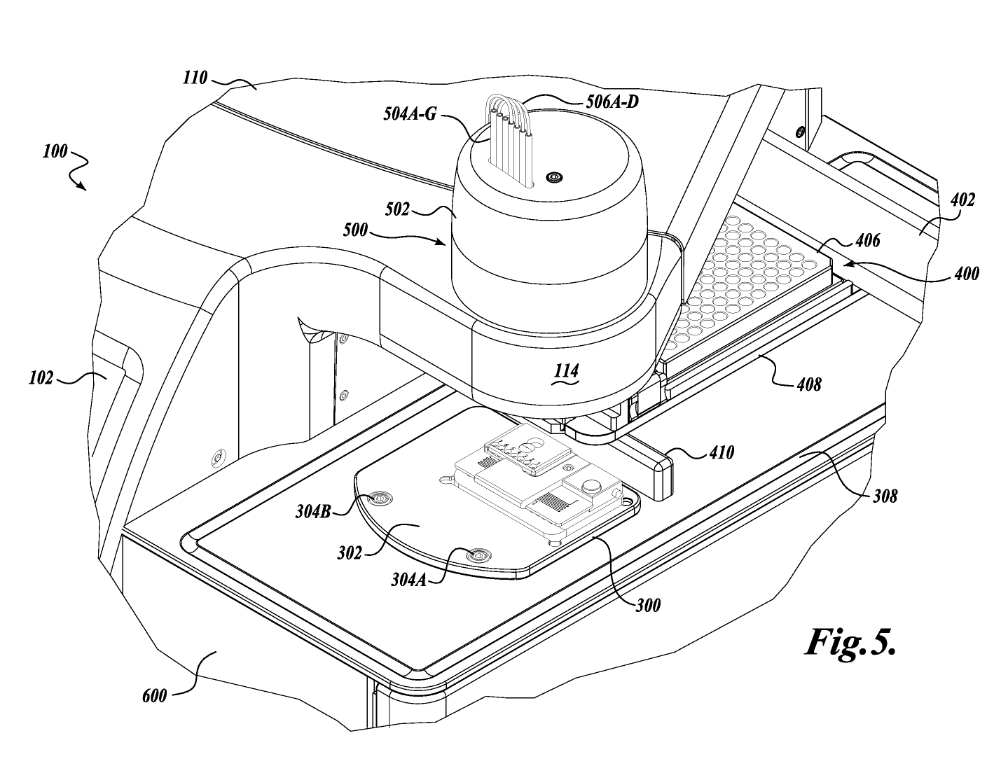

FIGS. 4 and 5 illustrate the robot 100 rightward from the front. The drip stage 108 is visible on top of the side box 600. A side box lock 106 allows access to the innards of the robot 100, which includes mechanisms to provide compression/decompression force on the experimental stage 300 to create fluid-tight joints, camera, lighting, USB coupler, keyboard port, mouse connection, separate power connection for each pump 208A-D, RS-232 communication connection to each pump to control its behavior (all of which are electrically coupled together to the USB coupler), and computer peripherals. The side box lock 106 is suitably made of tamperproof jet barrel lock. Bordering along the perimeter of the drip stage 108 are gutters 308, which function to catch accidental spillage of liquids during orchestration of microfluidic experiments by the robot 100. The drip stage 108 covers the entirety of the top of the side box 600 and is located below the ledge 114 and an XY stage 408, which is controlled by the carriages of the XY plane robot 400.

On top of the drip stage 108 is the experiment platform 300. The experiment platform 300 is configured to receive a microfluidics device vis-à-vis a well-aligned pressure fit that is sealed by gaskets. Adjacent to the experiment platform 300 is a supporting fence 410. The supporting fence 410 not only acts to delimit the position of the experiment platform 300 so as to prevent the experiment platform 300 from slipping toward the Y carriage 402 of the XY plane robot 400, but also provides bottom support for the XY stage 408 although the XY stage 408 suitably does not touch the supporting fence 410 so as to allow freedom of movement. The experimental platform 300 includes a secured stage 302, which is secured to the drip stage 108 vis-à-vis Allen bolts 304A, B. Hovering above the supporting fence 410 is the XY stage 408, which is attached to the Y carriage 402 of the XY plane robot 400. Placed on top of the XY stage 408 toward its distal terminus is the 96-well plate 406.

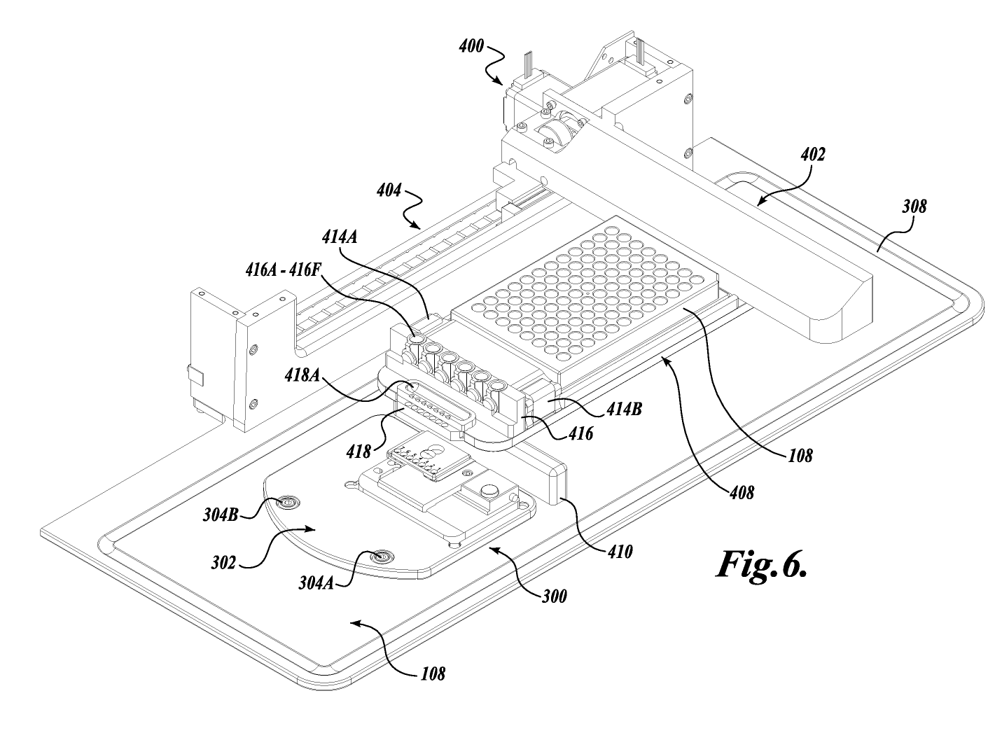

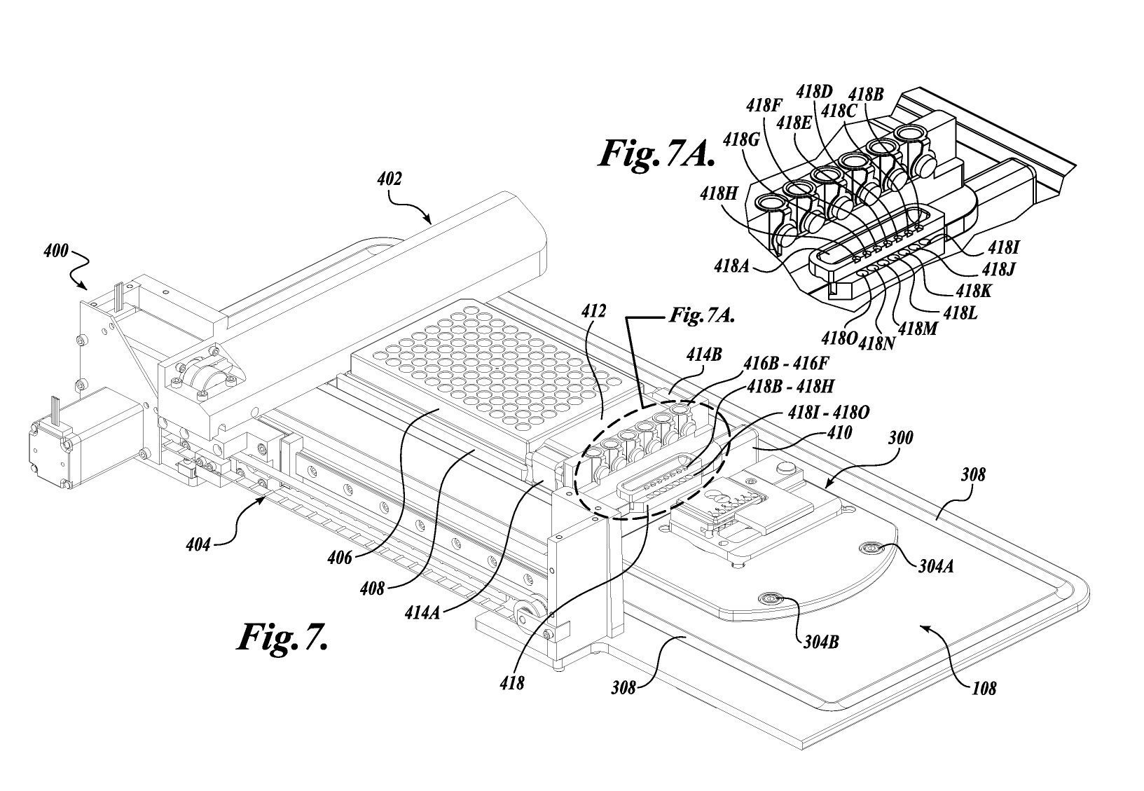

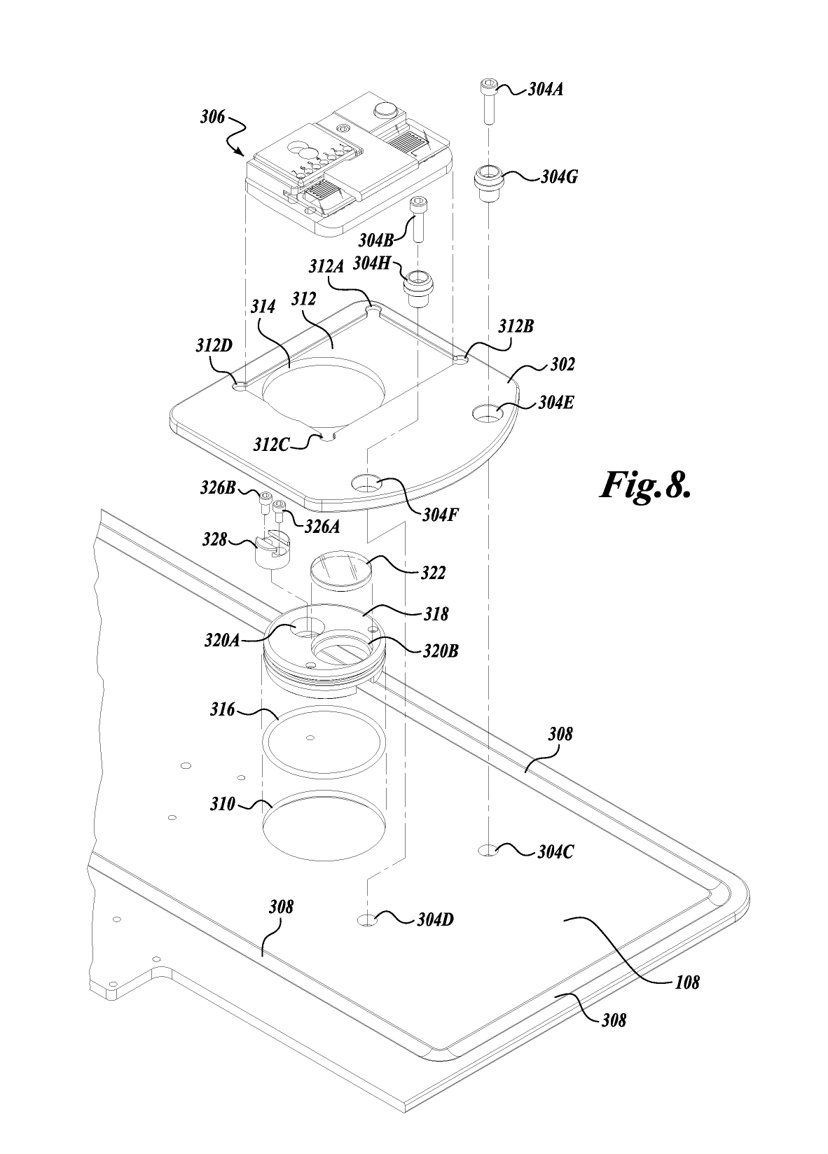

FIG. 6 illustrates the XY plane robot 400 rightward whereas FIG. 7 illustrates the XY plane robot 400 leftward with many details removed for the sake of clarity. The 96-well plate 406 moves in the same direction as the XY stage 408 when the XY plane robot 400 causes it to move transversely with respect to the Y carriage 402 to a particular position as commanded by software. In other words, the 96-well plate 406 rests on top of the XY stage 408, which is attached to the Y carriage 402, and which can be caused to move longitudinally along the Y-axis direction (parallel to an X carriage 404) by the XY plane robot 400. The XY plane robot 400 includes the X carriage 404 to which the Y carriage 402 is electromechanically coupled. The Y carriage 402 can be caused by the XY plane robot 400 to move transversely with respect to the X-axis orientation of the X carriage 404. In other words, the XY stage 408 (and therefore the 96-well plate 406) can be moved and positioned longitudinally along the X-axis direction (parallel to the Y carriage 402) when the Y carriage 402 is moved by the X carriage 404 while under software control.

Proximally adjacent to the 96-well plate 406 is a blotter structure 414, which houses a piece of blotter paper 412 snapped into place by blotter locks 414A, B. Proximally adjacent to the blotter structure 414 is a tube rack 416. The tube rack 416 houses various O.D. tubes 416A-F, and pockets of the tube rack 416 are available to secure caps of the various tubes 416A-F so that they do not interfere with experiment orchestration by the robot 100. Suitably the tubes 416A-F are about 1/16 inch diameter in size. At the proximal terminus of the XY stage 408 is an XY terminus device 418. See FIG. 7A. The XY terminus device 418 is divided into an upper portion and a lower portion. The XY terminus device 418 is positioned partially beyond the proximal terminus of the XY stage 408. The upper portion of the XY terminus device 418 includes a trough 418A into which liquids can be discarded from the termini of tubes 506A-D when instructed to do so by the Z-head robot 500 under software control. Adjacent to the trough 418A and positioned partially beyond the proximal terminus of the XY stage 408 are XY upper guide hemicycles 418B-H. Respectively aligned with each of the XY upper guide hemicycles 418B-H are XY lower guide holes 418I-O in the lower portion of the XY terminus device 418.

When the Z-head robot 500 lowers a sheath 504A-G and therefore a respective tube 506A-D to make contact with an interface assembly 306, the particular sheath 504A-G and associated tube 506A-D passes through one of the respective XY lower guide holes 418I-O, which provides planar guidance by the XY plane robot 400 under software control of a particular experimental protocol. In other words, if the tube 506A were to be introduced through the XY lower guide hole 418I, it will further guide the tube 506A to a suitable location on a guide orifice 342A of the interface assembly 306. If the tube 506B were to be introduced through the XY lower guide hole 418J, it will further guide the tube 506B to a suitable location on a guide orifice 342B of the interface assembly 306. If the tube 506C were to be introduced through the XY lower guide hole 418K, it will further guide the tube 506C to a suitable location on a guide orifice 342C of the interface assembly 306. If the tube 506D were to be introduced through the XY lower guide hole 418L, it will further guide the tube 506D to a suitable location on a guide orifice 342D of the interface assembly 306. The remaining tubes, if any, are similarly guided to the remaining guide orifices 342E-G of the interface assembly 306 using the remaining XY lower guide holes 418N, O.

FIG. 8 illustrates the experiment platform 300 in exploded details. The experiment platform 300 is secured to the drip stage 108 vis-à-vis Allen bolts 304A, B, which respectively slide through shanks 304G, H; shank holes 304E, F defined on a secured stage 302; and Allen holes 304C, D, defined on the drip stage 108. The experiment platform 300 is slidingly removable from the Allen bolts 304A, B, while the Allen bolts 304A, B remain fastened to the drip stage 108. The experiment platform 300 includes the interface assembly 306, which fits inside a cavity 312. The cavity 312 is a space hollowed out from the secured stage 302. Suitably, the cavity 312 is a rectangular form whose corners 312A-D are further hollowed out to form a substantially circular shape to permit lifting the interface assembly 306 off from the cavity 312 by a fine tip instrument. The bottom of the cavity 312 further defines a cavity opening 314 to expose additional interface components that are oriented below the secured stage 302.

Just below the cavity opening 314 is a cap cylinder 318 that is circular in shape and accommodates a coupling hole 320A and a light hole 320B. The cap cylinder 318 has an annular side and it is threaded to fasten to either the secured stage 302 or the drip stage 108. The light hole 320B has an annular shelf, which is fitted with a glass lens 322 for conducting light to observe a microfluidic experiment contained in a microfluidics device 326 held by the interface assembly 306. The coupling hole 320A accommodates a female coupler 328, which is fastened by coupling bolts 328A, B to a compression/decompression structure 602 configured to assist in the creation of a fluid-tight joint in the interface assembly 306. The female coupler 328 has a substantially cylindrical shape with top and bottom surfaces. Boring through the top surface to the bottom surface are coupling holes 328C, D, for receiving the coupling bolts 328A, B. Protruding in parallel from the top surface of the female coupler 328 are two D-shaped hooks that are substantially hemicycle in shape. Underneath the cap cylinder 318 is a washer 316, which is fitted over a light well 310.

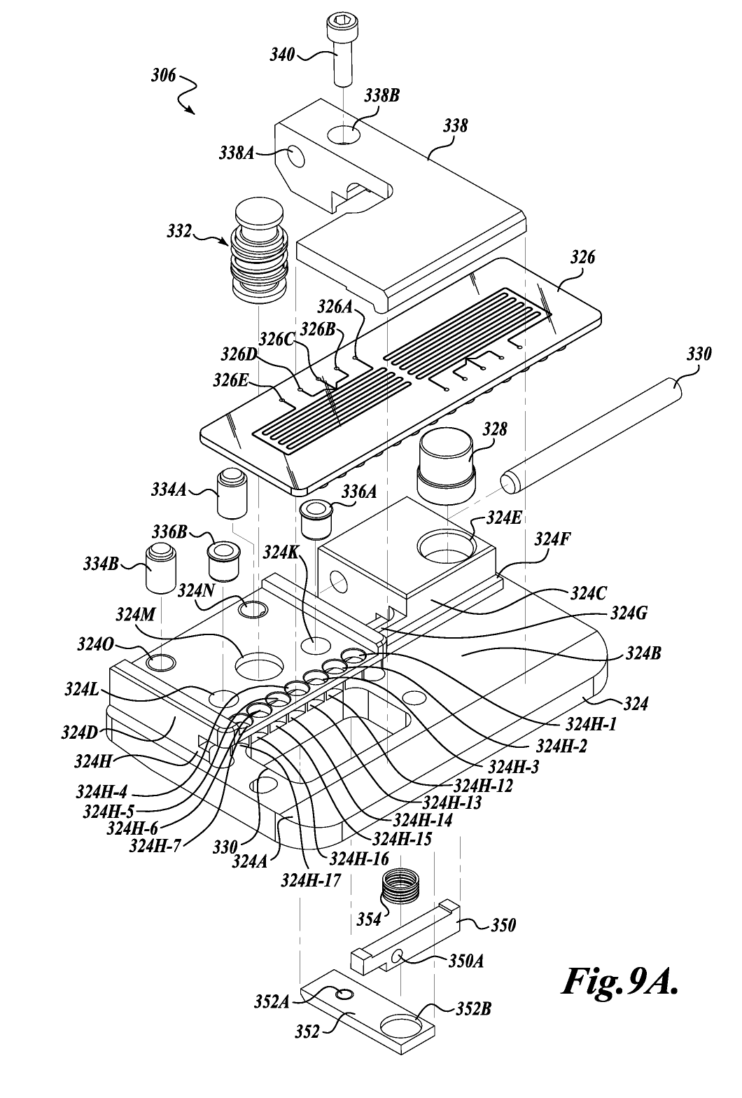

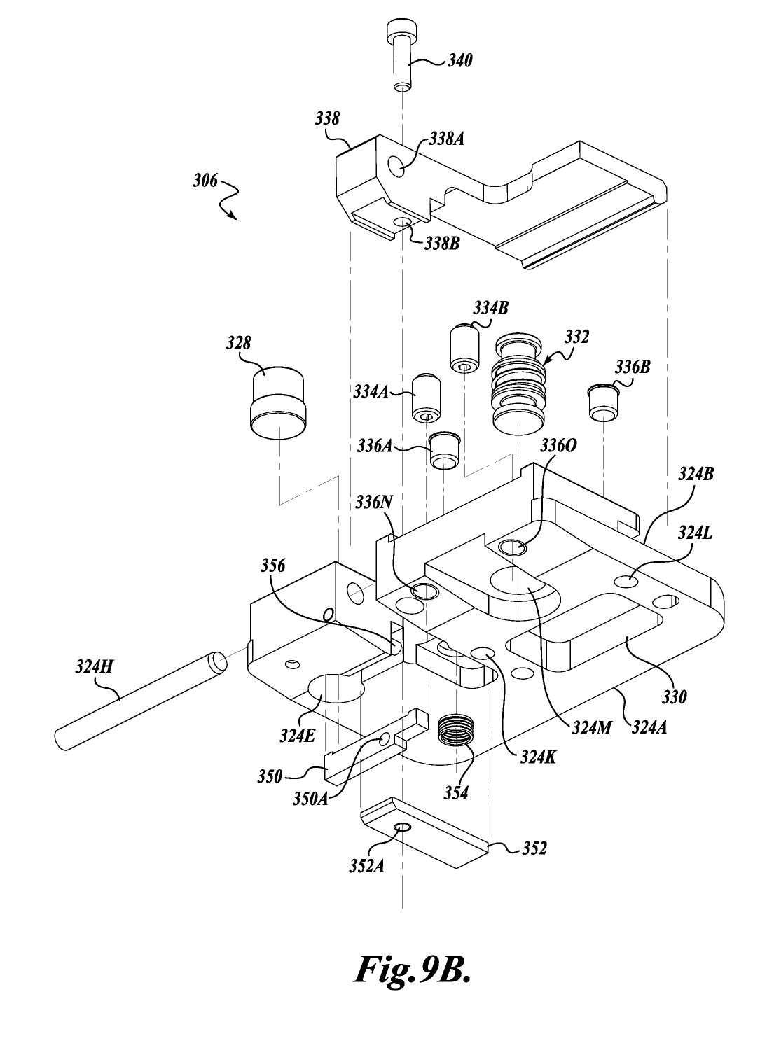

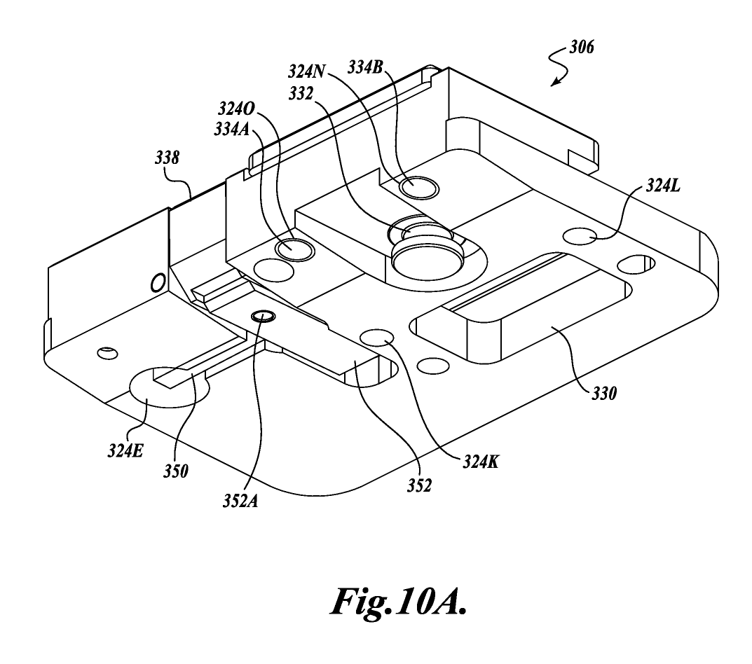

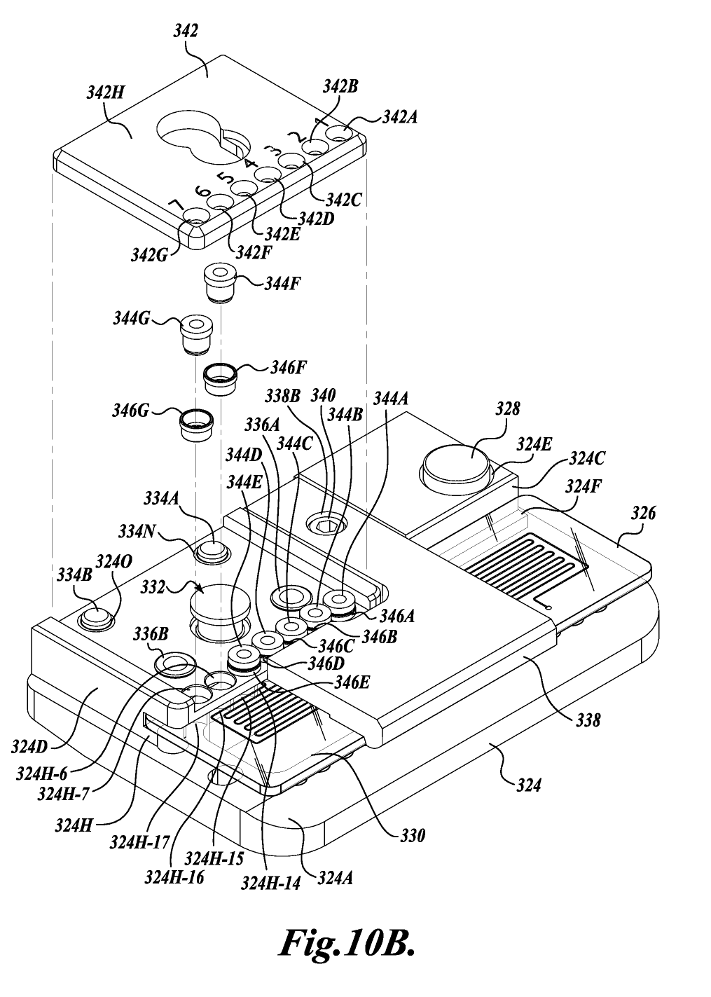

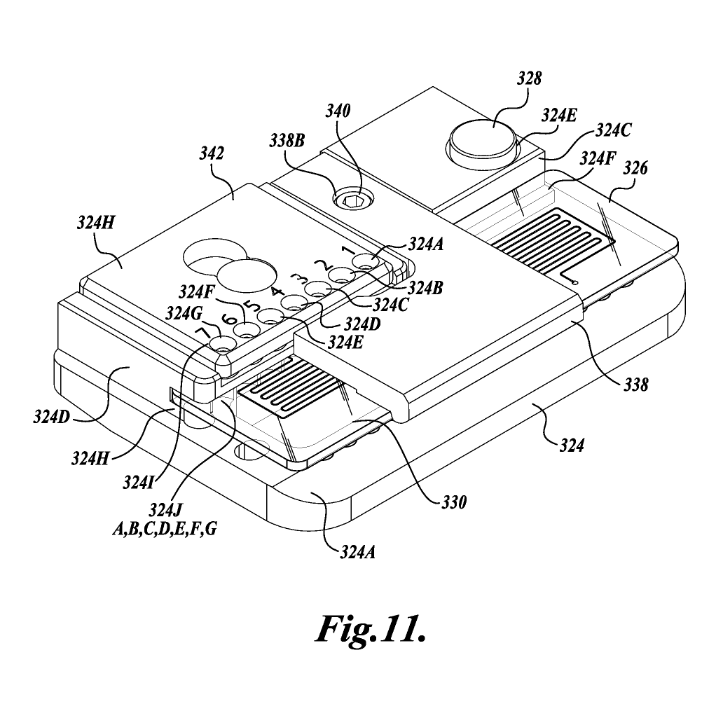

FIGS. 9A, 9B, 10B illustrate the interface assembly 306 in exploded detail. FIGS. 10A, 11 illustrate the interface assembly 306 in assembled detail. The interface assembly 306 is built from an interface platform 324 that has numerous sections. One of the sections is an interface front 324A, which is a sloped proximal terminus. Behind the interface front 324A at a slight decline is another section, an interface nest 324B, which acts as a receptacle to receive the microfluidics device 326. The interface nest 324B includes an interface light well 330 for conducting light toward the microfluidics device 326 so as to allow a camera (not shown) oriented below to image microfluidics experiments performed inside the microfluidics device 326. The camera communicates with the robot 100 via the USB connection that suitably is electrically coupled to the pumps 208A-D. Manual X-Y adjustments allow a user to improve image quality by changing the length of the lens and by focusing on an area of interest on the microfluidics device 326. Two adjustable LEDs (not shown) provide a light source for illumination for the camera to image the microfluidics device 326.

Adjacent to the interface nest 324B is a rocker structure 324C that includes rocker stairs 324G and rocker step 324F. This rocker structure 324C also includes a rocker buttonhole 324E to house a release button 328. A slidable rocker rod 330 is disposed into the rocker structure 324C. Also adjacent to the rocker structure 324C is a lower macro-micro interface 324D whose top includes a hole 324M through which a column 332 protrudes; bearing hollows 324K, L; and bolt hollows 324N, O. The lower macro-micro interface 324D has a C-shaped front 324H whose upper terminus houses various interface ports 324H-1, 2, 3, 4, 5, 6, and 7, and whose lower terminus houses hemicycles 324H-11, 12, 13, 14, 15, 16, and 17. Fitted into the bearing hollows 324K, L are bearing structures 336A, B. Fitting into bolt hollows 324N, O are bolts 334A, B. Snapped into the lower macro-micro interface 324D between the interface ports 324H-1-7 and the hemicycles 324H-11-17 is the microfluidics device 326. A subset of the columnar ports of the microfluidics device 326 fit into the hemicycles 324H-11-17, which respectively align with five interface apertures 326A-E of the microfluidics device 326, and which further respectively align with axial centers of a subset of the interface ports 324H-1-7.

Gripping the microfluidic device 326 into tension with the C-shaped front 324H of the lower macro-micro interface 324D is an L-shaped member 338. The L-shaped member 338 can be levered by pushing the rocker button 328 to cause a distal terminus of the L-shaped member 338 to raise up so as to receive the microfluidics device 326 into the C-shaped front 324H of the lower macro-micro interface 324D and lodge the microfluidics device 326 into the interface nest 324B. The L-shaped member 338 is fastened to the interface platform 324 via a bolt 340 sliding through a bolt hole 338b and terminating securely through a lever hole 352A. The L-shaped member 338 has a portion at its proximal terminus which has been cored to define a rocker bore 338A to house the rocker rod 330. The rocker rod 330 allows the L-shaped member 338 to pivot between a release position upon actuation by the rocker button 328 and a gripping position to secure the microfluidics device 326 as described above. Upon actuation of the rocker button 328 vis-à-vis a downward press, the bottom of the rocker button 328 communicates a downward force to a finger 350 at its proximal terminus. The finger 350 pivots on a pivot rod 356, which is housed by the rocker structure 324C, causing the distal terminus of the finger 350 to lever downward thereby pushing down on a distal terminus of a lever 352. Because the lever 352 is mechanically coupled to the L-shaped member 338 via the bolt 340, the downward orientation of the lever 352 causes the proximal terminus of the L-shaped member 338 to pivot to a release position. In other words, the proximal terminus of the L-shaped member 338 pivots downward and correspondingly the distal terminus of the L-shaped member 338 is pushed upward to receive the microfluidics device 326. A spring 354, which sits in a spring sink 352B at a proximal terminus of a lever 352, elastically recovers a previous location of the lever 352 when the pressure on the rocker button 328 is removed.

Fitted through the hole 324M is a column 332. See FIG. 10B. The proximal terminus of the column 332 finishes with a disc, and similarly, the distal terminus of the column 332 also finishes with another disc. One of the disc termini is used to latch the interface assembly 306 to a compression/decompression structure 602, and the remaining disc terminus is used to latch to an upper macro-micro interface 342, thereby when the compression/decompression structure 602 exerts a downward force, the upper macro-micro interface 342 is also pulled downward and causes a distribution of compression force between the upper macro-micro interface 342 and the lower macro-micro interface 324D. Fitted into the interface ports 324H-1-7 are numerous rings 346A-G, and fitted inside the rings 346A-G are gaskets 344A-G. The upper macro-micro interface 342 includes a number of guide orifices 342A-G. At the center of the upper macro-micro interface 342 is a latch structure 342H comprising two annular, abaxial voids. One of the annular, abaxial voids has a shelf for latching to the disc terminus of the column 332. Each guide orifice 342A-G is axially aligned with each respective interface ports 324H-1-7 and each respective hemicycles 324H-12-17.

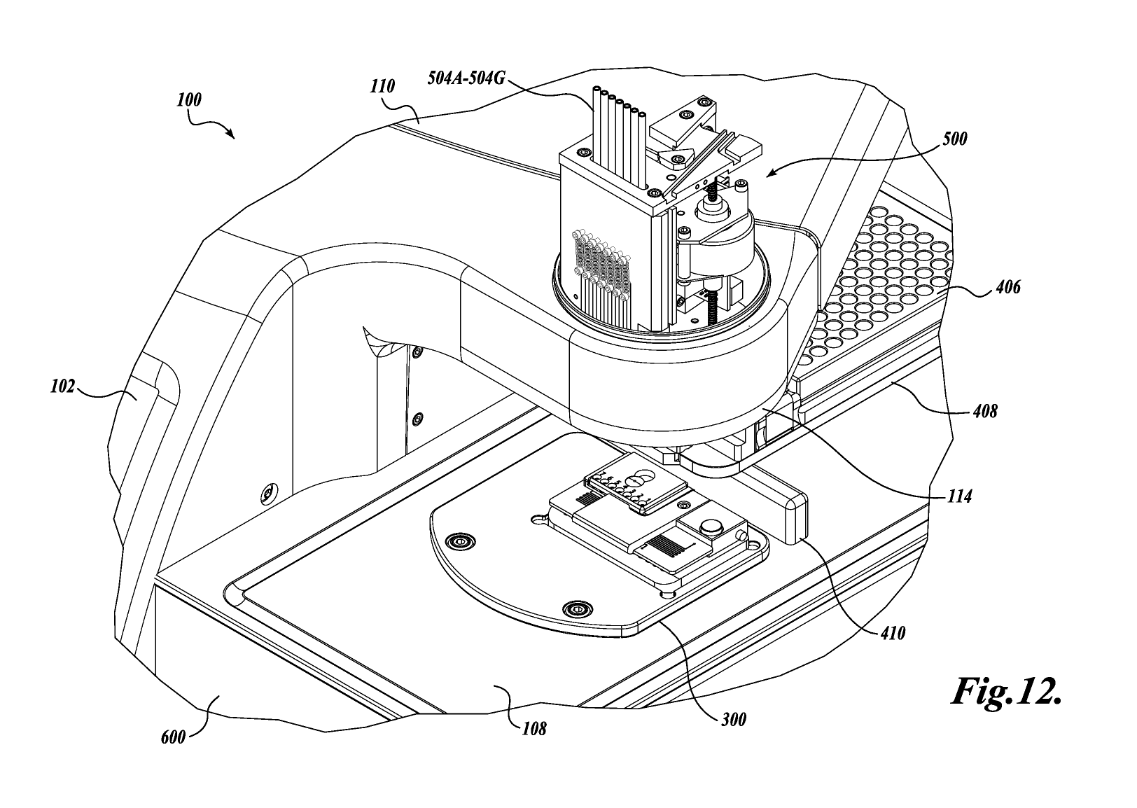

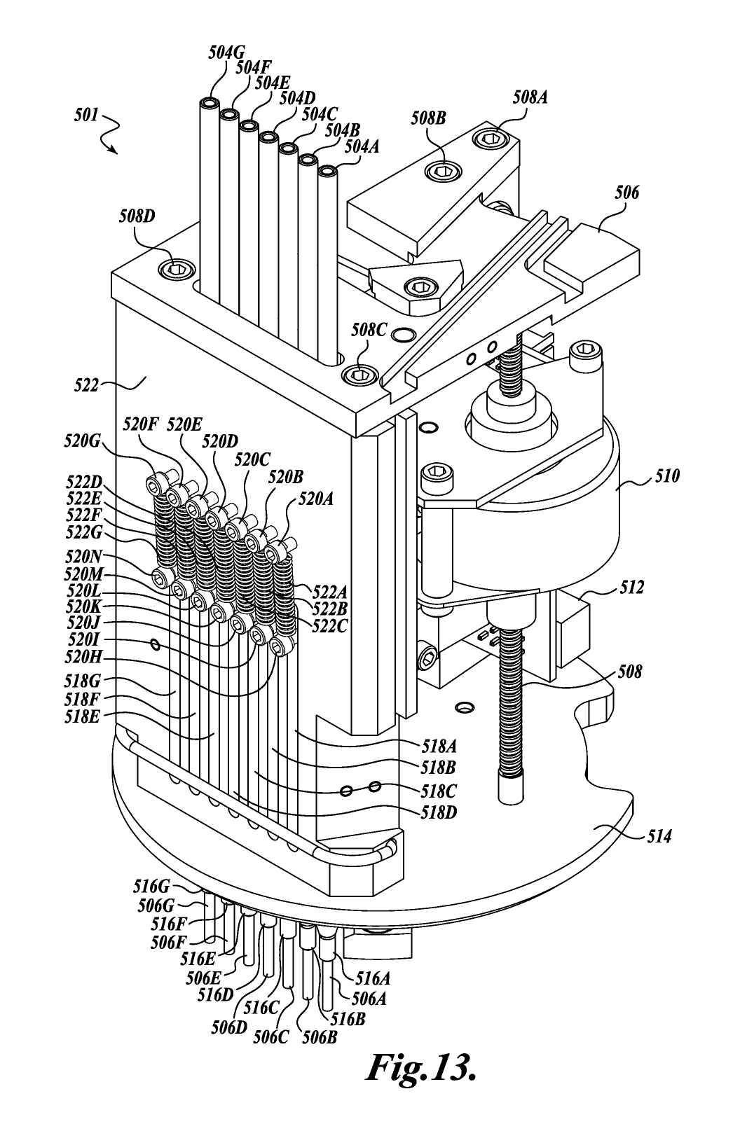

FIGS. 12-17B illustrate the innards 501 of the Z-head robot 500 in greater detail. The innards 501 are revealed by FIG. 12 when the cover 502 for the Z-head 500 are removed. As shown, the innards 501 rest on the ledge 114 of the robot 100. The innards 501 are magnified as illustrated by FIG. 13 to reveal specific parts. Top bolts 508A-D fasten an innards cover 506 to other structural components of the innards 501, such as an innards back 512 and an innards front 522. Interposed between the innards cover 506 and an innards bottom 514 is a worm 508, which is a long rod whose threads gear with the teeth of a worm wheel inside a vertical motor 510. The vertical motor 510, when actuated, moves components of the innards 501 up or down on the worm 508, thereby imparting vertical movements to the sheaths 504A-G.

The innards back 512 is one of the structural components to which the top bolts 508A, B fasten the innards cover 506. Protruding through the innards bottom 514 are the sheaths 504A-G, which are capped by sheath tips 516A-G, each of which is screwed onto a distal terminus of a sheath 504A-G. Extending beyond the sheath tips 516A-G are various tubes 506A-G for conducting fluids. The innards front 522 is fastened to the innards cover 506 via the top bolts 508C, D. Fastened to the innards front 522 is a set of front bolts 520A-G. Another set of front bolts 520H-M are slidingly positioned in grooves 518A-G. A set of springs 522A-G are coils, whose termini are circular hooks. Each circular hook at each terminus of a spring 522A-G is configured to loop to a front bolt 520A-G and the other hook to loop to a respective front bolt 520H-M.

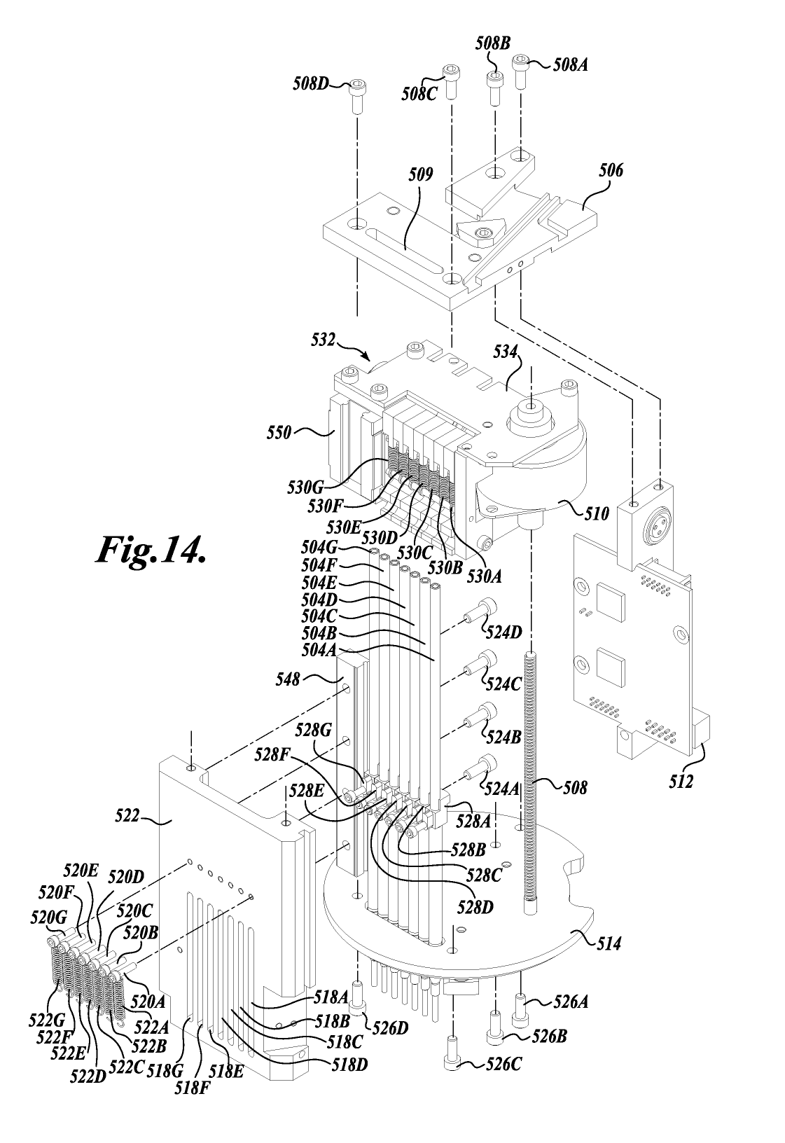

The innards 501 are exploded in FIG. 14 to facilitate examination of the components in greater detail. The innards cover 506 includes a sheath opening 509 that is configured to work in combination with the sheath opening 508 of the Z-head robot 500's cover 502 to receive the sheaths 504A-G. The innards 501 include a selection mechanism 532, which houses a set of female selectors 530A-G. The selection mechanism 532 includes a vertical track 550 with parallel, facing sides, one side having a convex protrusion facing another convex protrusion of the other side. The track 550 slidably fits into a guide 548 that is superposed over the innards bottom 514. The guide 548 has parallel sides that face away from each other, each side having a concave notch that complementarily fits a respective convex protrusion of the track 550. Rear bolts 524A-D fasten the innards front 522 to the guide 548. Additionally, bottom bolts 526A-D fasten the innards front 522 and the innards back 512 to the innards bottom 514.

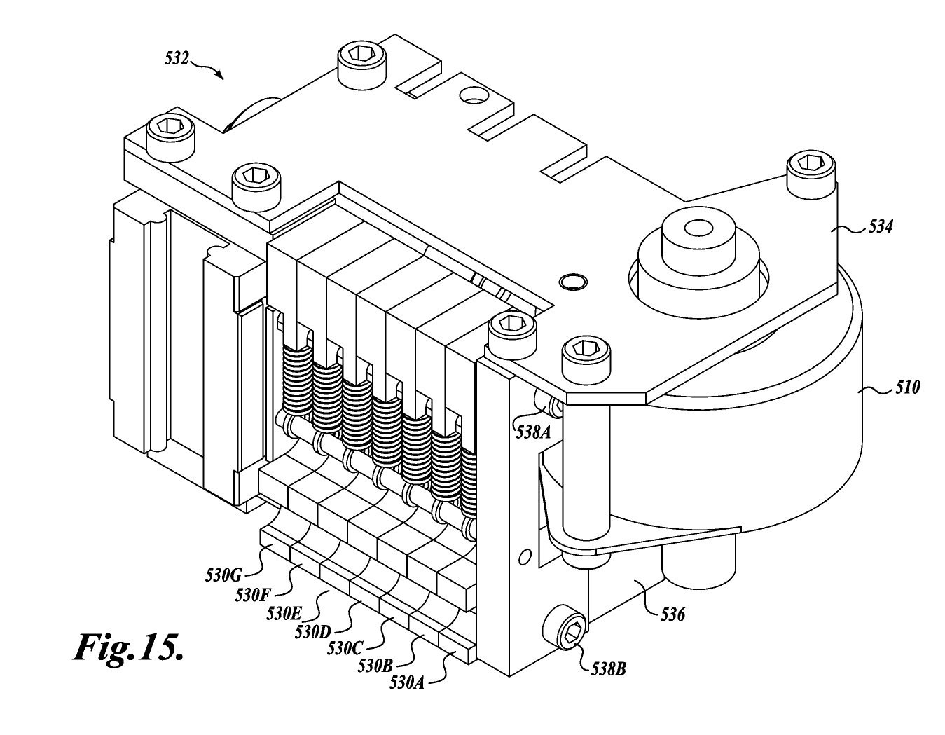

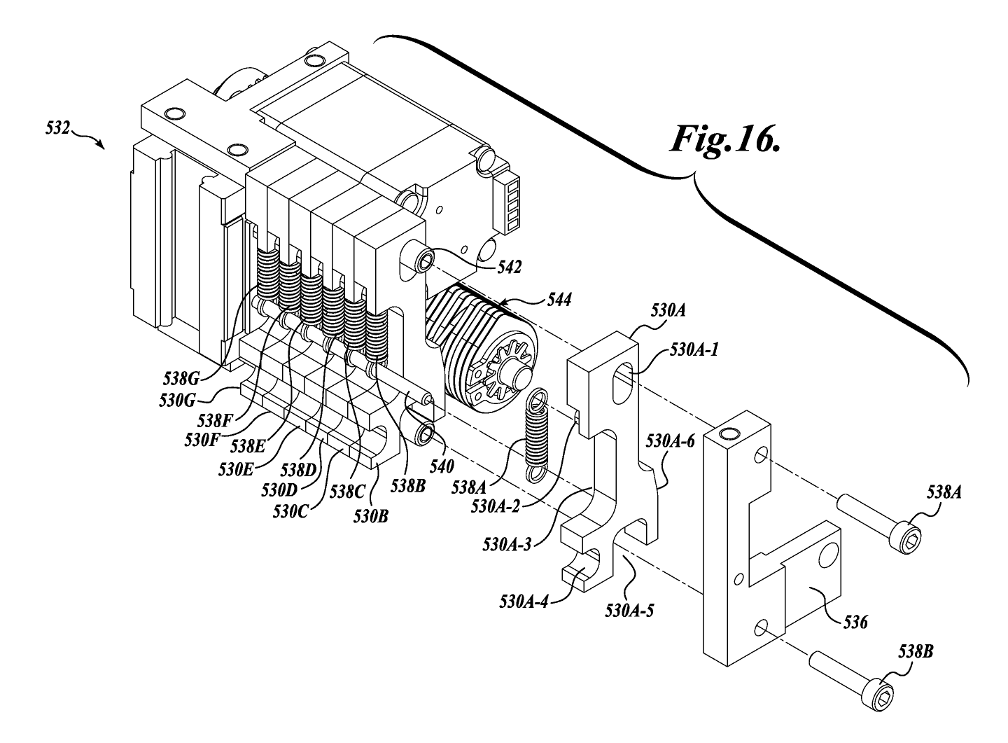

The selection mechanism 532 is magnified in an assembled, isometric view to allow examination of its components in greater detail. See FIG. 15. The selection mechanism 532 includes a selection mechanism cover 534, which is fastened to a selection side 536 via various bolts including side bolts 538A, B. A hole at the top of the selection mechanism cover 534 exposes a portion of the vertical motor 510 where the worm 508 protrudes to terminate at the bottom of the innards cover 506. The selection mechanism 532 is exploded so that its components can be examined in further detail. See FIG. 16. Each female selector 530A-G includes a hole 530A-1. A selector hanging rod 542 is positioned to receive the female selectors 530A-G through the respective hole 530A-1 of each so as to allow the female selectors 530A-G to hang from the selector hanging rod 542.

Each female selector 530A-G includes a protrusion 530A-2 attached to which is a circular hook terminus of a selector spring 538A-G. Each female selector 530A-G includes selector openings 530A-3, A-4, and A-5. Each female selector 530A-G includes a female selector back 530A-6. The selector opening 530A-5 of each female selector 530A-G is positioned over a lower rod 552, which restrains forward movement by the female selectors 530A-G. The selector opening 530A-3 is positioned behind a selector tension rod 540 through which the remaining circular hook terminus of the selector spring 538A-G is secured. The subset of the remaining selector springs 538B-G are positioned similarly to the selector spring 538A. The selector springs 538A-G help to bring respective female selectors 530A-G back to their original position prior to selection by the cam. The side bolt 538A secures the female selectors 530A-G by causing the selection mechanism side 536 to abut against the female selector 530A as it slides through the hole 530A-1 to fasten to the terminus of the selector hanging rod 542.

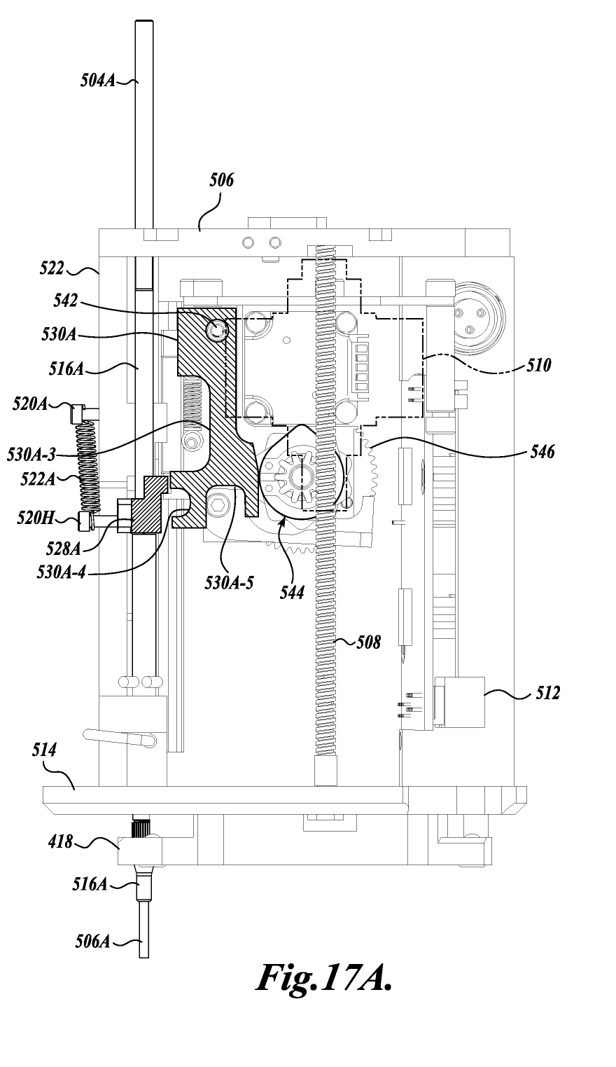

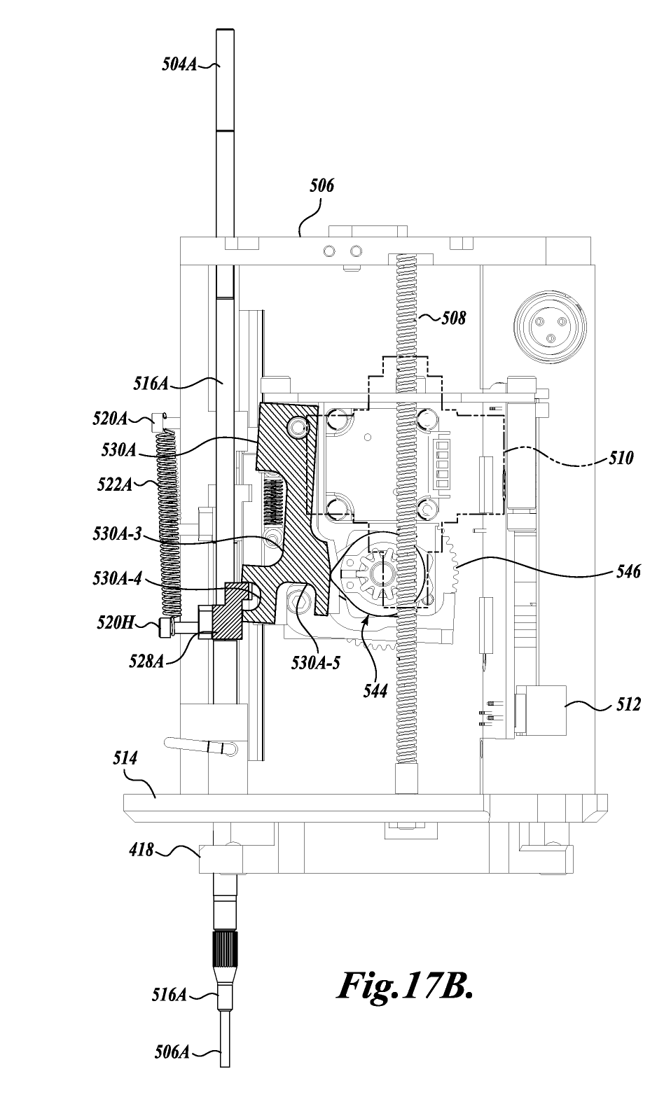

Similarly, the side bolt 538B further secures the female selectors 530A-G by causing the selection mechanism side 536 to abut against the female selector 530A by protruding through the selector opening 530A-5 to fasten to the terminus of the lower rod 552. The selection mechanism 532 includes a cam 544, which is an assembly of disk members with apices that rotate to transform rotary motion into linear motion. Suitably, the apices are initially set at 90-degree angle while in a pre-selection state. See FIG. 17A. When commanded by an executing piece of software, a cam motor 546 drives the cam 544 to select one or more of the female selectors 530A-G. The process of selecting one or more of the female selectors 530A-G includes lowering one or more apices of the disk members of the cam 544 so that these one or more apices are now at zero degrees to contact one or more female selector backs 530A-6.

When an apex of a disk member of the cam 544 contacts the female selector back 530A-6 of a particular female selector 530A-G, a linear displacement occurs, forcing the female selector 530A-G to swing forward on the selector hanging rod 542. See FIG. 17B. The selector opening 530A-4 terminates in a C-shaped void, which mates with a terminus of an S-shaped male selector 528A-G. Because each S-shaped male selector 528A-G is fastened to a particular sheath 504A-G, when a particular S-shaped male selector 528A-G mates with a particular female selector 530A-G, a particular sheath 528A-G is selected by the selection mechanism 532 under the control of the Z-head robot 500 via software. When the vertical motor 510 moves downward on the worm 508, the vertical motor 510 causes the selected sheath or sheaths 504A-G to correspondingly move downward. The tube 506A-G sheathed by the selected sheath 504A-G is linearly driven by the lowering sheath 504A-G to be guided by an XY lower guide hole 418I-O and by a guide orifice 342A-G of the upper macro-micro interface 342.

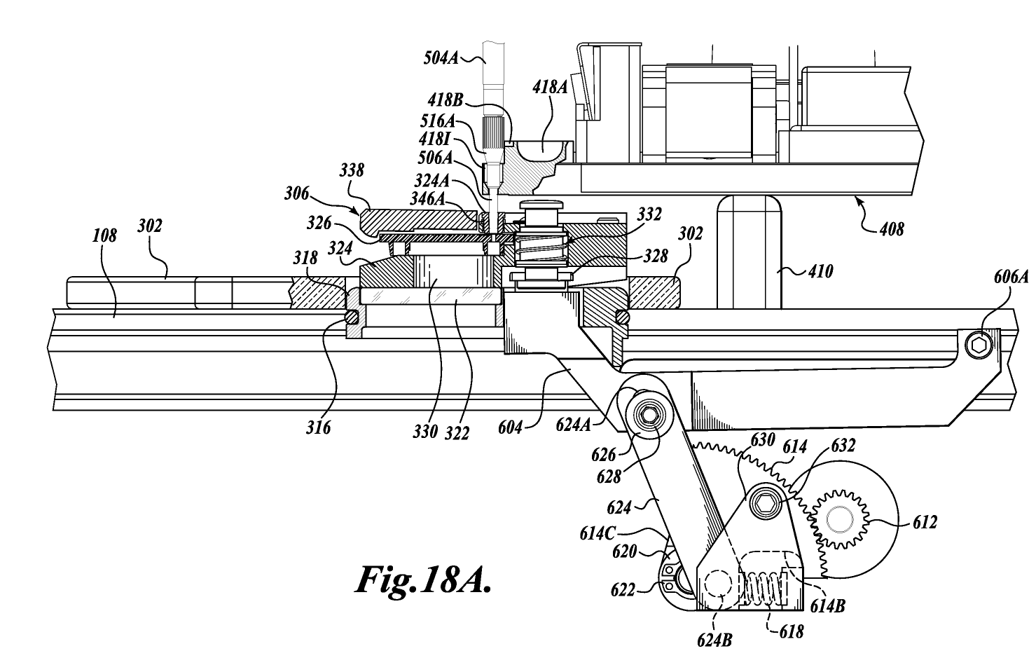

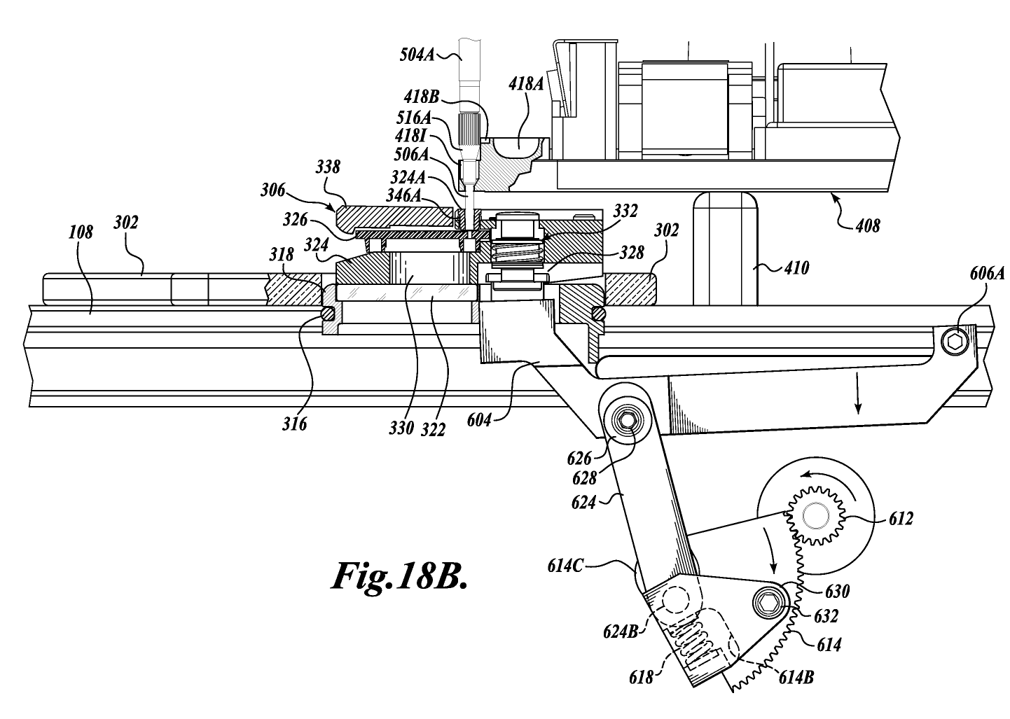

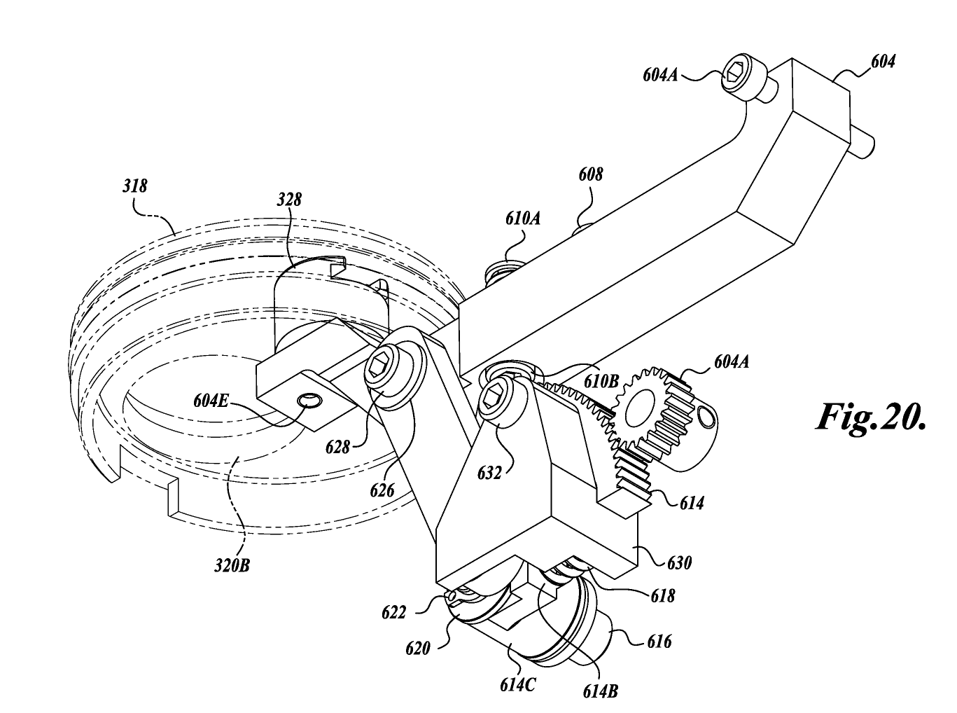

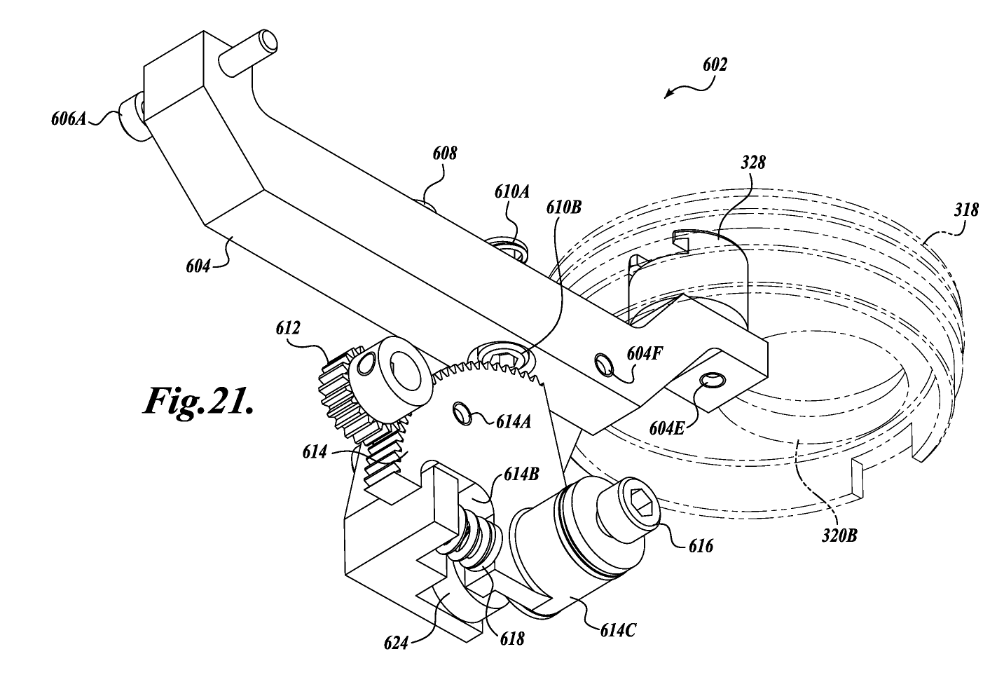

FIGS. 18A-22 illustrate the compression/decompression structure 602 in detail. The compression/decompression structure 602, when commanded by executing piece(s) of software, pulls the female coupler 328 downward. Correspondingly, the female coupler 328, which couples to the column 332, pulls its disc terminus downward. Correspondingly, another disc terminus of the column 332, which latches to the latch structure 342H of the upper macro-micro interface 342, pulls the upper macro-micro interface 342 downward. Such downward forces cause a fluid-tight joint to be formed among the set of the gaskets 344A-G, which surround one or more tubes 506A-D.

FIG. 18A illustrates a partial cross-sectional side view of the robot 100 showing a pre-compression state or decompression state where a clearance exists between the disc terminus of the column 332 and the upper macro-micro interface 342. FIG. 18B illustrates a compression state where there is no clearance between the disc terminus of the column 332 and the upper macro-micro interface 342. An arrow illustrates a counter-clockwise rotational force of a pinion 612 configured to communicate with the teeth of the quadrantal gear 614, which rotates clockwise as illustrated by another arrow. The rotation of the quadrantal gear imparts a downward linear motion to a brace 624, which pulls an elbow of an arm 604 downward. Coupled to a terminus of the arm 604 is the female coupler 328, which proceeds to cascade further downward forces to create a compression state as discussed hereinbefore.

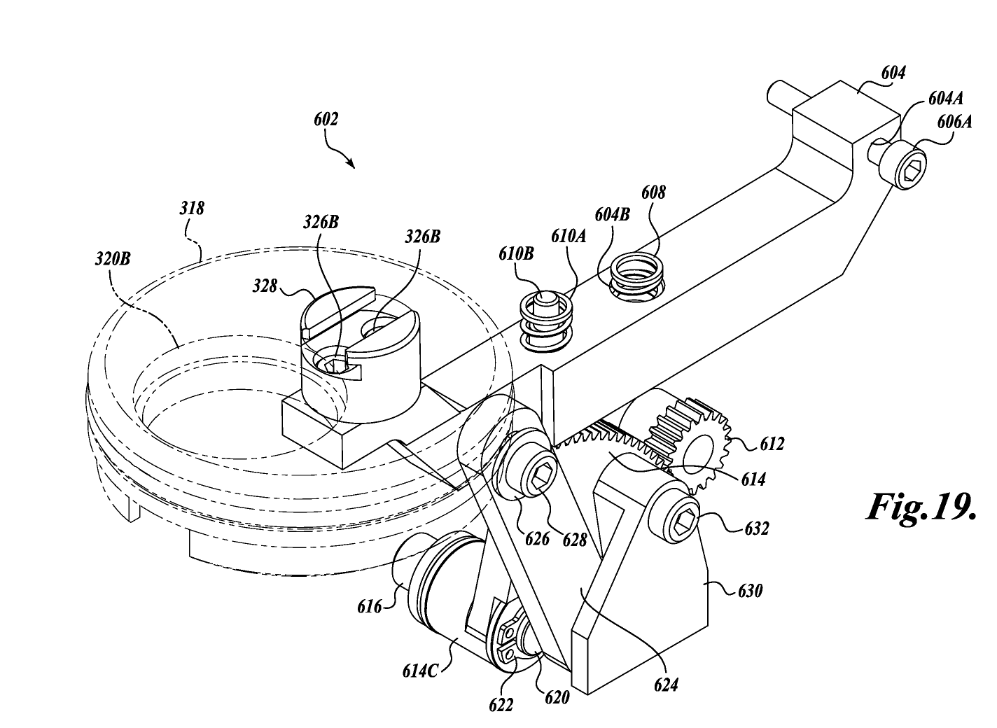

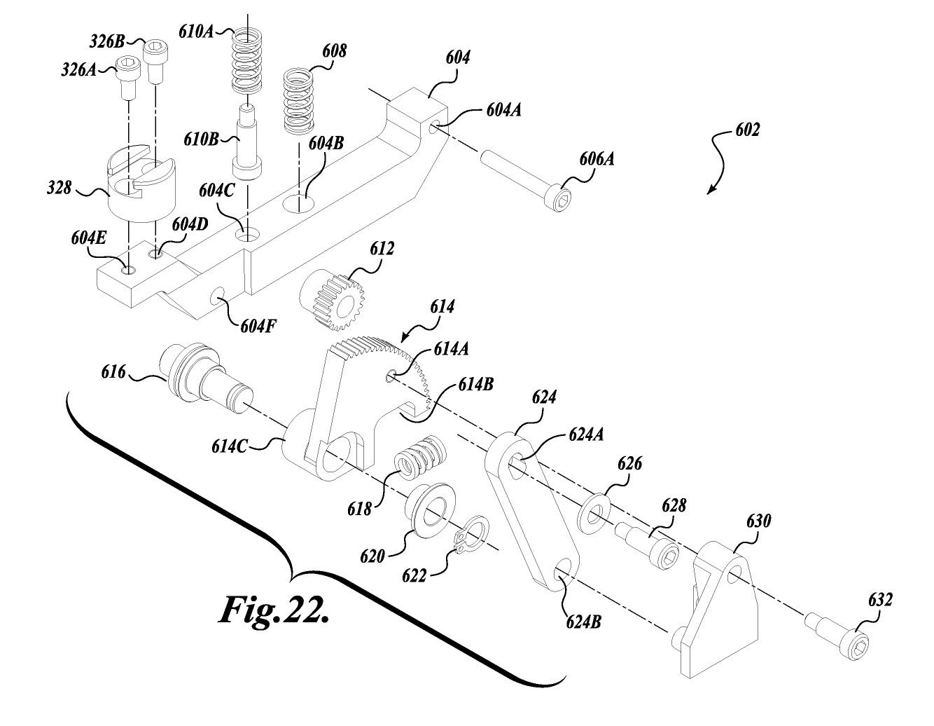

FIGS. 19, 20, and 21 illustrate an assembled perspective view of the compression/decompression structure 602. FIG. 22 illustrates an exploded perspective view of the compression/decompression structure 602. The compression/decompression structure 602 includes the arm 604, which at one terminus a hole 604A accommodates a bolt 606A for fastening the arm 604 to the robot 100. At the other terminus, the arm 604 includes holes 604D, E to secure the female coupler 328 when the bolts 326A, B fasten the female coupler 328 to couplings 328A, B. The arm 604 includes a further hole 604B to accommodate a spring 608. A hole 604C on the elbow of the arm 604 accommodates both a pin 610B and a spring 610A. A hole 604F is configured to receive through the brace 624 a bolt 628, which is threaded through a washer 626 and a hole 624A of the brace 624.

Another hole 624B on the brace 624 receives a pin 616 whose proximal terminus slides through an annular chamber 614C of a quadrantal gear 614, washer 620, and fastener 622 to terminate at an annular projection on a gear body 630. The gear body 630 includes a hole that accommodates a bolt 632 that slides through a hole 614A of the quadrantal gear 614. The compression/decompression structure 602 further includes the pinion 612 that communicates with the quadrantal gear 614 to actuate the arm 604. A spring 618 is disposed in the spring chamber 614B of the quadrantal gear 614 and the gear body 630.

In operation, the robot 100 functions as follows for a few embodiments that are directed to gradient crystallization experiment protocol. The robot 100 may function differently depending on other experiment protocols. The gradient crystallization experiment protocol produces a concentration gradient of a single crystallant over a series of aqueous droplets inside the microfluidics device 326. The pumps 208A-D are primed by the robot 100. Users put fluorocarbon solutions, crystallant, buffer, and protein, as well as the microfluidics device 326 into their proper locations. The user then uses the touchscreen 102 to invoke a desired experimental protocol. The experimental protocol, through associated software, controls the XY plane robot 400 to move the XY stage 408 and the Z-head robot 500 to move, alone or in combination, the sheaths 504A-G.

The experimental protocol, upon receiving a start command, proceeds to execute an aspiration command and in response the XY stage 408 orients the tube rack 416 beneath the ledge 114 where the sheaths 504A-G of the Z-head robot 500 are located. One or more sheaths 504A-G move downward into one or more tubes 416A-F and desired amounts of one or more off-chip materials are aspirated into the tubes 506A-D. In one embodiment, the robot 100 may aspirate a small separation gas bubble before and/or after aspirating off-chip materials. As soon as the off-chip materials are aspirated, to better minimize evaporation the XY plane robot 400 moves the XY stage 408 to allow a set of the sheaths 504A-G to access the microfluidics device 326. A set of the tubes 506A-G are pushed downward to be possibly guided by a set of the XY lower guide holes 418I-O in the lower portion of the XY terminus device 418.

The set of the tubes 506A-G are further guided by the guide orifices 342A-G of the upper macro-micro interface 342 to enter a set of the gaskets 344A-G housed by the lower macro-micro interface 324D and terminate at the five interface apertures 326A-E of the microfluidics device 326. The two adjustable LEDS are then illuminated to allow the camera to image microfluidics experiment in the microfluidics device 326. The experiment is then orchestrated by the robot 100 during which time off-chip fluids and off-chip materials are introduced to the microfluidics device 326. When the experiment is finished, the pumps 208A-D stop, the sheaths 504A-G retract into the Z-head 502 cover, and the microfluidics device 326 is now ready to be removed for inspection. The user can initiate a cleaning command to instruct the Z-head robot 500 to work in combination with the XY plane robot 400 to allow the sheaths 504A-G to expel waste into the trough 418A. Afterward, the robot 100 causes the tubes 506A-D to be reprimed with fluids, such as fluorocarbon, from one or more vials 224A-D.

As described above, in some embodiments, the sheaths 504A-G of the Z-head robot 500 are orchestrated by the robot 100 to move, but in a few embodiments, the sheaths 504A-G remain stationary while the robot 100 causes components of the experiment platform 300 to move towards the sheaths 504A-G, and in some additional embodiments, the robot 100 causes both the sheaths 504A-G and the components of the experiment platform 300 to move so as to facilitate fluidics experiments. While illustrative embodiments have been illustrated and described, it will be appreciated that various changes can be made therein without departing from the spirit and scope of the invention.

The embodiments of the invention in which an exclusive property or privilege is claimed are defined as follows:

1. A robot for orchestrating fluidic experiments, comprising:
a macro-micro interface assembly configured to receive a microfluidics device; and
a Z-head configured to protract a sheath, which houses a tube having a terminus that mates with the macro-micro interface assembly to make a fluid-tight joint for communicating fluid into the microfluidics device, the Z-head being further configured to retract the sheath to unmake the fluidic-tight joint between the terminus of the tube and the microfluidics device.

2. The robot of claim 1, further comprising a valve having three ports, one port being coupled to the tube, another port being coupled to a vial tube, which is further coupled to a vial, and a remaining port being coupled to a syringe, which is further coupled to a pump.

3. The robot of claim 1, further comprising an XY plane robot, which further comprises an X carriage and a Y carriage that is electromechanically coupled to the X carriage, the Y carriage supporting an XY stage on which a 96-well plate, a blotter structure, a tube rack, and an XY terminus device rest.

4. The robot of claim 1, wherein the macro-micro interface assembly comprises a female coupler, which has a substantially cylindrical shape with two D-shaped hooks that are substantially hemicycle in shape that protrude in parallel from the top surface of the female coupler.

5. The robot of claim 4, further comprising a compression/decompression structure, which is linked to the female coupler by a column whose termini finish with discs, one of the disc termini latched to the two D-shaped hooks of the female coupler and the other disc terminus latched to the macro-micro interface assembly to the compression/decompression structure so that a compression force is distributed to the macro-micro interface assembly when the compression/decompression structure exerts a downward force.

6. An interface assembly, comprising:
an upper macro-micro interface configured to define a number of guide orifices; and
a lower macro-micro interface configured to define a front whose upper terminus houses various interface ports and whose lower terminus houses hemicycles, each guide orifice being axially aligned with each respective interface port and each respective hemicycle, fastened into the lower macro-micro interface between the interface ports and the hemicycles is a microfluidics device in which a subset of columnar ports of the microfluidics device fit into the hemicycles, which further respectively align with interface apertures of the microfluidics device.

7. The interface assembly of claim 6, wherein the upper macro-micro interface further defines a latch structure, which comprises two annular, abaxial voids, one of the annular, abaxial voids having a shelf, and wherein the lower macro-micro interface includes a hole that is axially aligned with the one annular, abaxial void that has a shelf.

8. The interface assembly of claim 7, further comprising a column, a proximal terminus of the column finishing with a disc, and a distal terminus of the column also finishing with another disc, one of the disc termini being used to latch the interface assembly to the shelf of the one annular, abaxial void of the upper macro-micro interface.

9. The interface assembly of claim 8, further comprising a rocker structure that includes rocker stairs, the rocker structure further including a rocker buttonhole to house a release button, a slidable rocker rod being disposed into the rocker structure.

10. The interface assembly of claim 9, further comprising an L-shaped member configured to grip the microfluidic device into tension with the front of the lower macro-micro interface, the L-shaped member configured to be levered when the release button is actuated to cause a proximal terminus of the L-shaped member to rock on the rocker stairs via the slidable rocker rod, a distal terminus of the L-shaped member being configured to raise up so as to receive the microfluidics device into the front of the lower macro-micro interface.

11. A Z-head robot, comprising:
a set of S-shaped male selectors fastened to a set of sheaths that house tubes;
a set of female selectors each of which includes a C-shaped selector opening; and
a cam, which is an assembly of disk members with apices that rotate to transform rotary motion into linear motion, the Z-head robot lowering one or more apices of the disk members of the cam so that the lowered apices contact one or more female selectors causing one or more C-shaped selector openings to mate with proximal termini of one or more S-shaped male selectors and thereby selecting one or more sheaths.

12. The Z-head robot of claim 11, further comprising a vertical track with parallel, facing sides, one side having a convex protrusion facing another convex protrusion of the other side, the vertical track being mechanically coupled to the set of female selectors, the track slidably fitting into a guide, the guide having parallel sides that face away from each other, each side having a concave notch that complementarily fits a respective convex protrusion of the track.

13. The Z-head robot of claim 12, further comprising a vertical motor that rotates around a worm, which is a long rod whose threads gear with the teeth of a worm wheel inside the vertical motor, wherein the vertical motor, when actuated, moves the selected S-shaped male selectors thereby imparting vertical movements to the selected sheaths.

14. The Z-head robot of claim 13, further comprising a hanging rod from which each female selector fastens to by a hole defined at a terminus of the female selector, each female selector including a protrusion attached to which is a circular hook terminus of a selector spring, the Z-head robot further comprising a selector tension rod through which the remaining circular hook terminus of the selector spring is secured.

15. The Z-head robot of claim 14, further comprising a set of springs whose termini are circular hooks, each circular hook at each terminus of a spring configured to loop to a respective front bolt mounted to a front and the other hook looping to another respective front bolt mounted to a distal terminus of an S-shaped male selector, the another respective front bolt slidingly positioned in a groove of the front.
